(19) United States
(12) Patent Application Publication
(10) Pub. No.: US 2015/0354490 A1
(43) Pub. Date: Dec. 10, 2015

(54) METHOD FOR OPERATING AN INTERNAL COMBUSTION ENGINE

(71) Applicant: MTU FRIEDRICHSHAFEN GMBH, Friedrichshafen (DE)

(72) Inventors: Armin DÖLKER, Friedrichshafen (DE); Johannes BALDAUF, Wangen (DE)

(21) Appl. No.: 14/653,718

(22) PCT Filed: Dec. 17, 2013
(86) PCT No.: PCT/EP2013/003819

§ 371 Date: Jun. 18, 2015

(30) Foreign Application Priority Data
Dec. 20, 2012 (DE) 10 2012 025 019.3

(51) Int. Cl. F02D 41/26; F02D 41/20

(52) U.S. Cl. CPC F02D 41/26; F02D 41/20; F02D 2041/2048

(57) ABSTRACT

The invention relates to a method and an assembly for operating an internal combustion engine. In the method, a correction of the fuel mass is dynamically decoupled from the calculation of the charging-pressure-dependent limitation.

The invention relates to a method for operating an internal combustion engine, in which a setpoint torque is calculated from an input variable which represents the desired power, wherein the setpoint torque is limited by a charging pressure-dependent limit.

During the torque-oriented closed-loop control of an internal combustion engine, a setpoint torque is ascertained by the closed-loop control system, and the internal combustion engine is actuated in a corresponding manner in order to set this setpoint torque. In this case, the setpoint torque is the actuating variable of the rotation speed controller.

Document DE 10 2004 011 599 B4 discloses a method for the torque-oriented open-loop control of an internal combustion engine. This method can also be applied in the case of an internal combustion engine having a plurality of exhaust gas turbochargers. In this method, a setpoint torque is calculated from an input variable which represents the desired power, and the setpoint torque is limited by an air mass-dependent maximum torque.

One disadvantage of this method is that, during load switching and when running up the engine, unstable behavior can occur, specifically whenever the setpoint torque is limited by the LDA curve (LDA: charging pressure-dependent), that is to say as a function of the charging-air pressure and the charging-air temperature.

The fuel mass is corrected as a function of the air mass ratio. Here, a two-dimensional weighting curve with the setpoint torque as the input variable is used in each case. If the weighting curve has a very steep transition, for example from the value 0 to the value 1 in the case of an increasing setpoint torque, and if the associated correction characteristic map comprises values which are greater than 1, then the result in the case of a rising setpoint torque in the transition region of the weighting curve is a positive fuel mass correction value, that is to say the setpoint fuel mass is raised.

A greater fuel mass leads to the calculation of a lower degree of efficiency. A lower degree of efficiency in turn leads to the calculation of a smaller LDA limiting torque. If the setpoint torque is limited by the LDA function during load switching or during run up, then the result is a setpoint torque which becomes smaller. Since the setpoint torque represents the input variable of the weighting curve, the correction value of the fuel mass and therefore also the setpoint fuel mass decrease as a result.

This leads to the calculation of a higher degree of efficiency, as a result of which the LDA limiting torque is raised. If the setpoint torque continues to be limited by the LDA function, then the result is a greater setpoint torque. As a result, the correction value of the fuel mass once again rises and, consequently, so does the setpoint fuel mass etc. This leads overall to an oscillating setpoint torque and therefore to an unstable rotation speed control loop.

Against this background, the invention proposes a method as claimed in claim 1 and an arrangement having the features of claim 7. Embodiments can be gathered from the dependent claims and the description.

In the method, a setpoint torque is calculated from an input variable which represents the desired power, for example an accelerator pedal position or a setpoint rotation speed, wherein the setpoint torque is limited by a charging pressure-dependent limit, wherein a correction of the fuel mass is dynamically decoupled from the calculation of the charging pressure-dependent limit.

A delay element can be used for the dynamic decoupling. Said delay element may be, for example, a filter. Dynamic decoupling is also achieved if a flat or horizontal curve profile is chosen for the weighting curve.

In a further embodiment, it is provided that, instead of a setpoint torque, a rotation speed controller I component is used as the input variable of a weighting curve.

Correction of the fuel mass can also be dynamically decoupled from the calculation of the charging pressure-dependent limit by calculation of a degree of efficiency being dynamically decoupled from the calculation of the LDA limiting torque.

The invention furthermore proposes an arrangement for carrying out the described method.

In the method, provision is therefore made for correction of the fuel mass to be decoupled from the calculation of the charging pressure-dependent limit.

According to the invention, stabilization of the rotation speed control loop is achieved by the calculation of the degree of efficiency being dynamically decoupled from the calculation of the LDA limiting torque. To this end, the degree of efficiency can be filtered, for example with the aid of a PT₁ filter. The time constant of this filter can be set by a parameter.

The proposed method has considerable advantages, at least in some of the embodiments. Owing to the dynamic decoupling of the fuel mass correction from the calculation of the charging pressure-dependent limit of the setpoint torque, the so-called LDA limit, stable use of the LDA limit is made possible. Therefore, instabilities are prevented.

Further advantages and refinements of the invention can be gathered from the description and the appended drawings.

It goes without saying that the features mentioned above and those still to be explained below can be used not only in the respectively specified combination but also in other combinations or on their own, without departing from the context of the present invention.

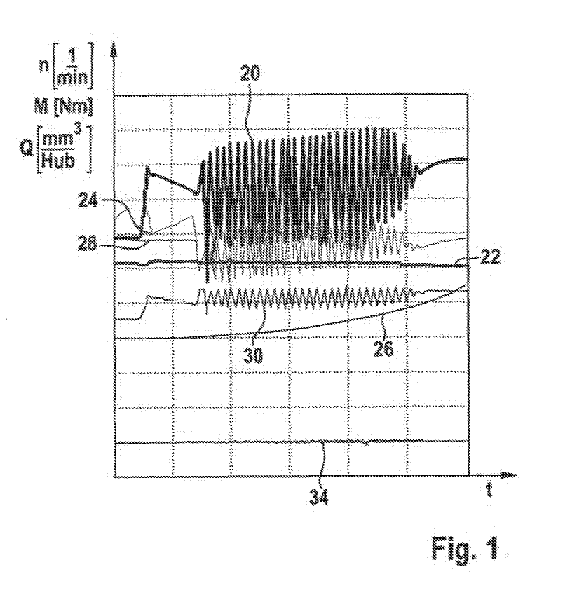

FIG. 1 shows an unstable behavior of an internal combustion engine in a graph.

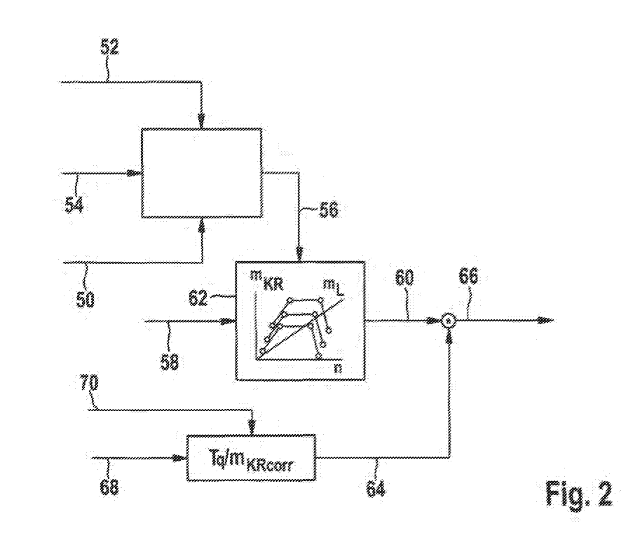

FIG. 2 shows the calculation of the LDA limit.

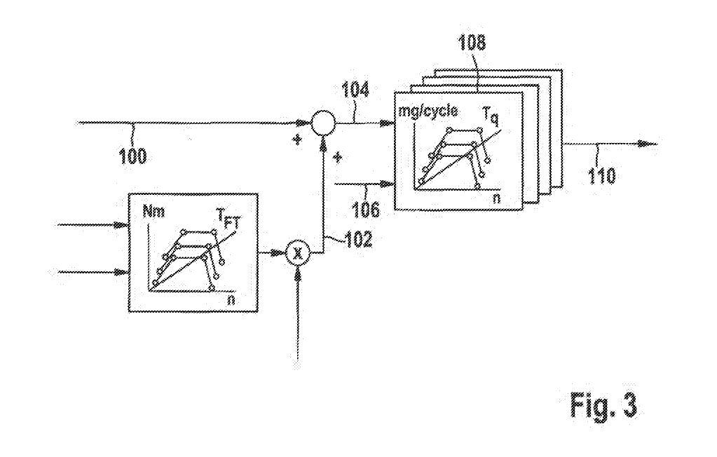

FIG. 3 shows the calculation of the standard fuel mass.

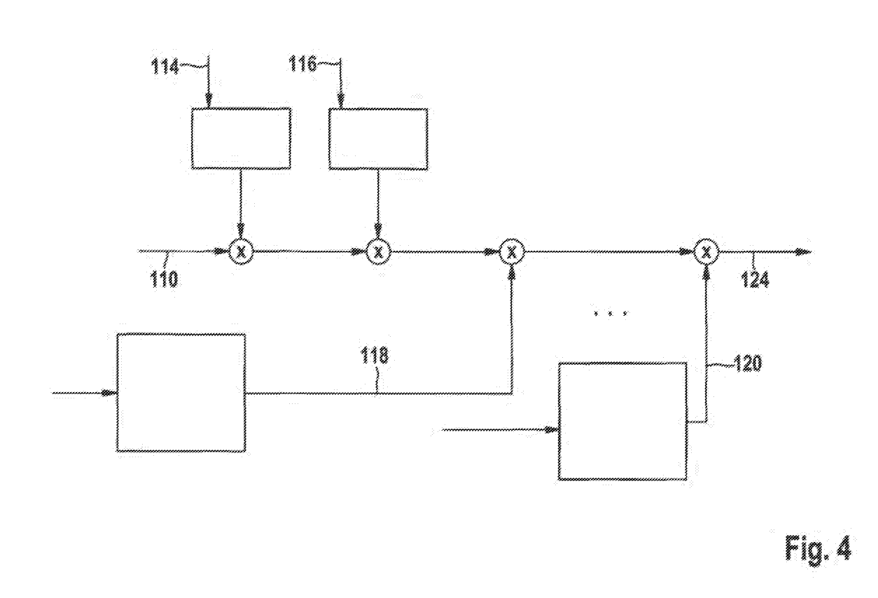

FIG. 4 shows the calculation of the corrected standard fuel mass.

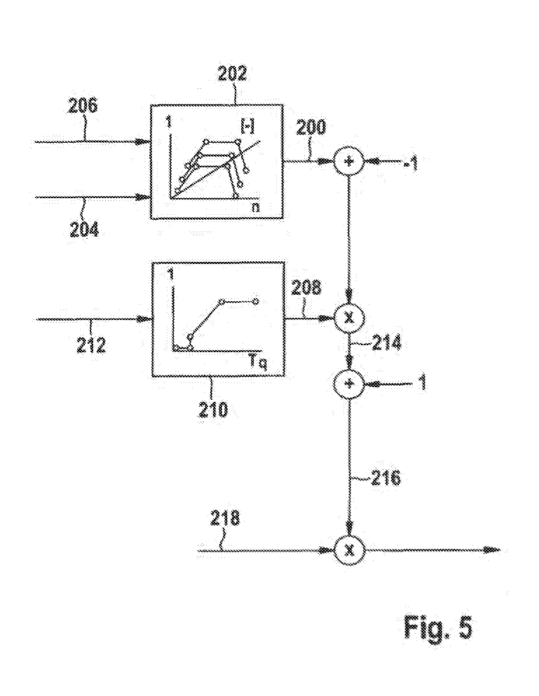

FIG. 5 shows correction of the fuel mass as a function of the air mass ratio.

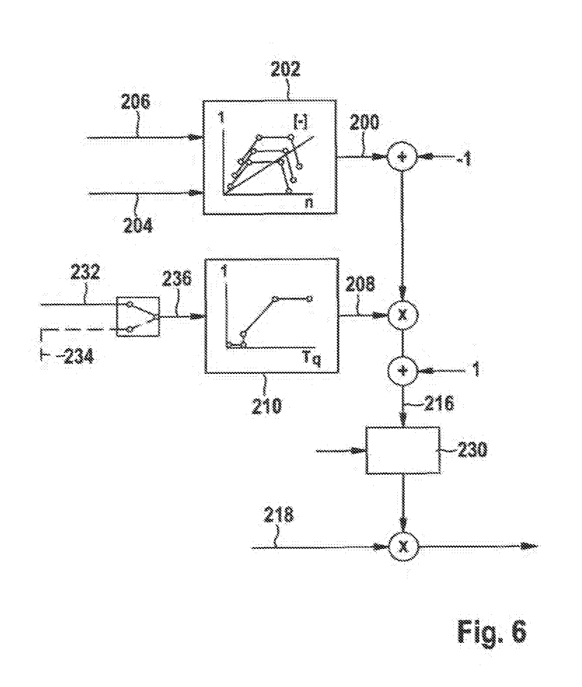

FIG. 6 shows further correction of the fuel mass as a function of the air mass ratio.

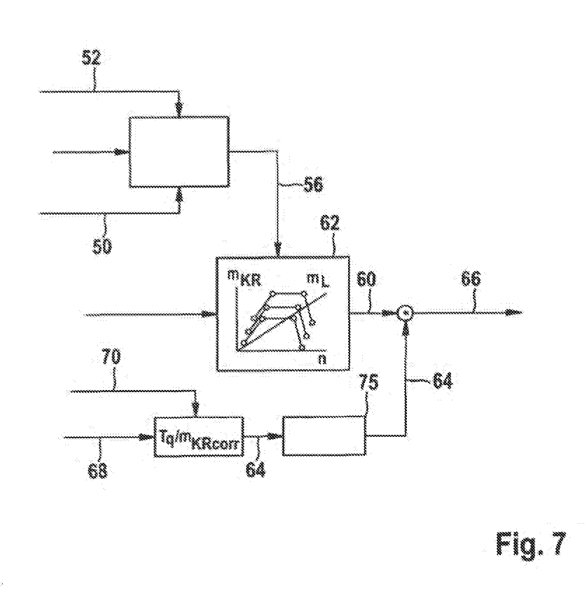

FIG. 7 shows further calculation of the LDA limit.

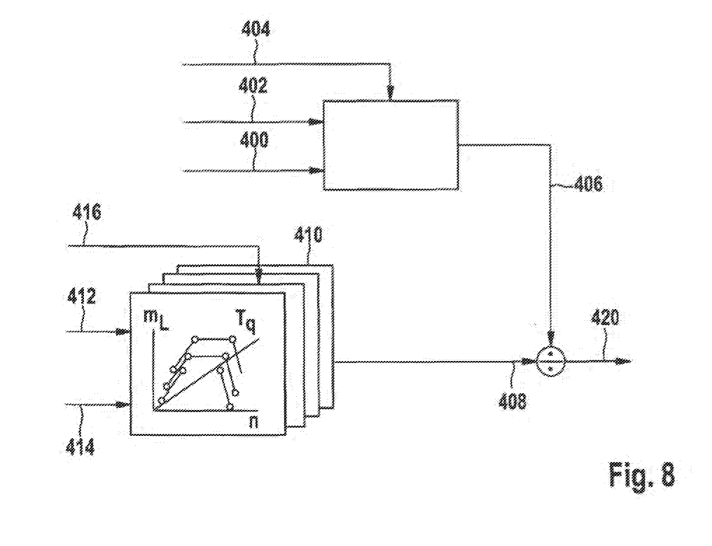

FIG. 8 shows the calculation of the air mass ratio.

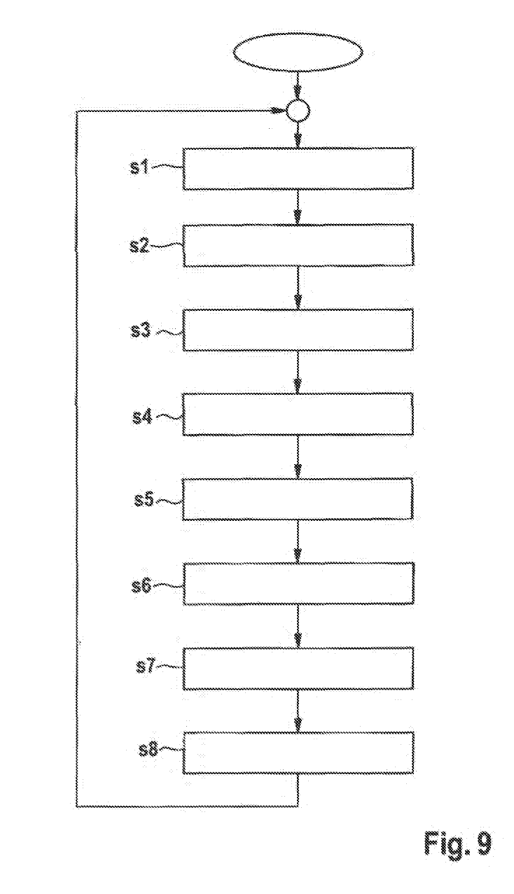

FIG. 9 shows the calculation of the LDA setpoint torque in a flowchart.

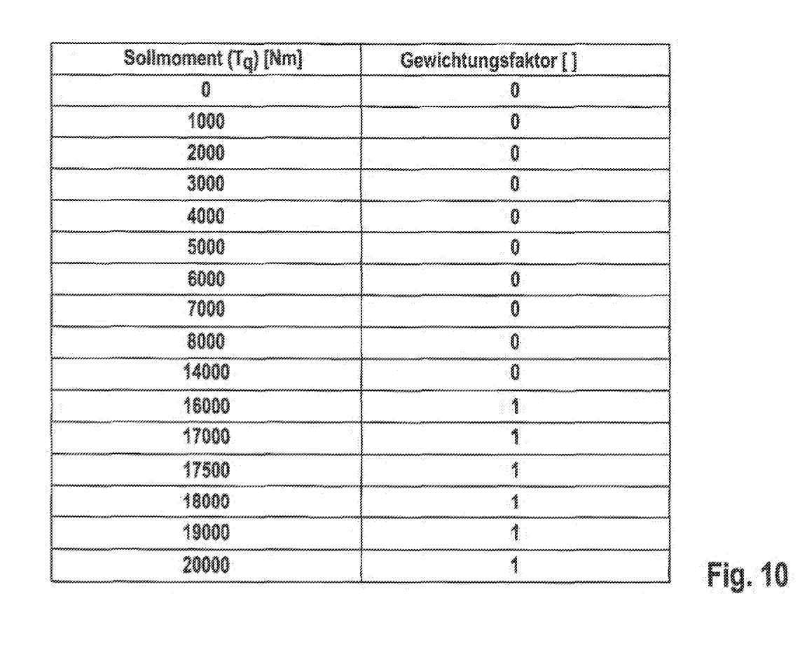

FIG. 10 shows values for the two-dimensional weighting curve.

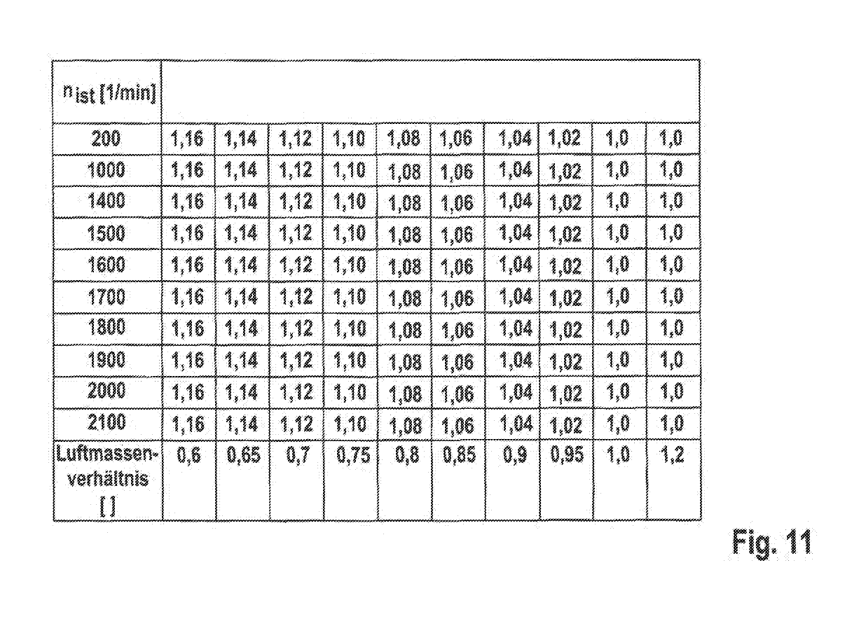

FIG. 11 shows values for the three-dimensional characteristic map of the air mass-dependent fuel mass correction.

The invention is schematically illustrated in the drawings using embodiments and will be described in detail below with reference to the drawings.

FIG. 1 illustrates instabilities during load switching in a graph. A first curve 20 shows the profile of the setpoint injection quantity, a second curve 22 shows the profile of the setpoint rotation speed, a third curve 24 shows the LDA limit, a fourth curve 26 shows the profile of the actual engine speed, a fifth curve 28 shows the profile of the maximum torque or setpoint torque, a sixth curve 30 shows the fuel mass correction value which is dependent on the air mass ratio, and a seventh curve 34 shows the fuel mass correction value which is dependent on the start-of-injection correction.

FIG. 1 therefore shows the unstable behavior of an internal combustion engine during load switching. In this case, the instability occurs precisely when the setpoint torque becomes identical to the charging pressure-dependent limit, specifically the LDA curve. As a result, severe oscillations in the setpoint torque, in the maximum setpoint torque and in the LDA limit occur. These variables are identical in this case since the setpoint torque is limited by the LDA curve and therefore so is the maximum setpoint torque. Since the setpoint torque oscillates, severe oscillations in the setpoint injection quantity occur.

FIG. 1 shows that, above all, the fuel mass correction value, which is dependent on the air mass ratio, also exhibits severe oscillations.

FIG. 2 shows the calculation of the LDA limit. The current air mass 56 is calculated from the charging-air temperature 50, the cylinder volume 52 and the charging-air pressure 54. The LDA fuel mass 60 is calculated from said air mass 56 and the actual engine speed 58 via an LDA characteristic map 62.

The LDA fuel mass 60 is converted into the LDA torque 66 by means of multiplication with the degree of efficiency 64. Here, the degree of efficiency 64 is calculated as the quotient of the setpoint torque 68 and the corrected standard fuel mass 70.

FIGS. 3 and 4 show how the corrected standard fuel mass is calculated.

The setpoint torque 100, as the output variable of the rotation speed controller or resulting from the accelerator pedal position, is firstly added to the frictional torque 102 here. The frictional torque represents the output variable of a three-dimensional characteristic map multiplied by the number of cylinders. The input variables of this characteristic map are the actual engine speed and a virtual temperature. This virtual temperature is calculated from two temperatures, for example the cooling water temperature and the oil temperature. The output variable of the characteristic map is the frictional torque of the engine, which frictional torque relates to one cylinder. The corrected setpoint torque 104 is given as the sum of the setpoint torque 100 and the frictional torque 102. From this corrected setpoint torque and the actual engine speed 106, the standardized fuel mass 110 is determined by means of the degree of efficiency characteristic map 108. Here, in the event of cylinder shutdown being activated or of changed engine tuning, a separate degree of efficiency characteristic map can be used.

The standardized fuel mass 110 is then corrected as a function of the air mass ratio 114. Further corrections, for example as a function of a start-of-injection correction 116, the ambient air temperature 118 and the fuel temperature 120 finally lead to the corrected standard fuel mass 124 which is used during the calculation of the LDA limit in order to ascertain the degree of efficiency.

The calculation of the corrected standard fuel mass 124 is described in document U.S. Pat. No. 7,203,589 B2.

FIG. 5 shows how the standardized fuel mass is corrected as a function of the air mass ratio: the value 1 is subtracted from the dimensionless output value 200 of a prespecifiable characteristic map 202 having the input variables air mass ratio 204 and actual engine speed 206. The result is multiplied by the output value 208 of a prespecifiable two-dimensional curve 210. This weighting curve 210 has the setpoint torque 212 as the input variable. The result 214 of the multiplication is then added to the value 1. The resultant sum 216 finally represents the multiplicative correction factor of the standardized fuel mass, which is multiplied by the standard fuel mass 218.

FIG. 6 shows the correction of the fuel mass as a function of the air mass ratio according to one embodiment of the proposed method.

FIG. 7 shows the charging-air pressure limit LDA according to one embodiment of the illustrated method.

FIG. 8 illustrates the calculation of the air mass ratio:

The current air mass 406 is calculated from the charging-air temperature 400, the charging-air pressure 402 and the cylinder volume 404. The standard air mass 408 is calculated from a three-dimensional characteristic map 410 which depends on the actual engine speed 412, the setpoint torque 414 and the charge-switching state 416. The air mass ratio 420 is calculated as the quotient of current air mass 406 and standard air mass 408.

The calculation of the air mass ratio is described in document U.S. Pat. No. 7,536,995 B2.

In the case of a lack of air, this dimensionless quotient is less than one. If there is an excess of air, then this quotient is greater than one.

The instabilities which are illustrated in FIG. 1 are explained below using the example of the correction of the fuel mass, which correction is dependent on the air mass ratio:

In FIGS. 10 and 11, values for the two-dimensional weighting curve and the three-dimensional characteristic map of the fuel mass correction are illustrated as a function of the air mass ratio by way of example:

If the setpoint torque is less than 14 000 Nm, then the weighting factor is equal to zero, and therefore the fuel mass is not corrected.

If the setpoint torque is greater than 16 000 Nm, then the weighting factor is equal to one. In this case, the prespecifiable three-dimensional characteristic map which is illustrated in FIG. 11 determines whether the fuel mass is corrected. If the air mass ratio is greater than 1.0, all the characteristic map values are identical to 1.0, that is to say the fuel mass is not corrected. In all other cases, the characteristic map values are greater than 1.0, and therefore the fuel mass is corrected, that is to say is enlarged by multiplication. If the air mass ratio drops, for example as a result of a load being connected, to the value 0.65 and the actual engine speed simultaneously drops to 1400 rev/min, then the fuel mass will be corrected upward by 14%.

If the setpoint torque is greater than 14 000 Nm and less than 16 000 Nm, then the weighting factor changes from the value 0 to the value 1. In this transition region, the correction of the fuel mass, which correction is dependent on the air mass ratio, begins to act, specifically the more intensely the greater the setpoint torque. If the actual engine speed drops as a result of a load being connected, then the rotation speed controller increases the setpoint torque. If said setpoint torque becomes greater than 14 000 Nm, then the fuel mass will be corrected upward since the air mass ratio drops at the same time. According to FIG. 2, a higher fuel mass results in a lower degree of efficiency and therefore a reduction in the LDA torque. If the setpoint torque is limited by the LDA torque, then the setpoint torque also drops with the LDA torque. This in turn leads to the air mass-dependent correction of the fuel mass being reduced. As a result, the degree of efficiency rises and the LDA torque is raised. Since the setpoint torque is limited by the LDA torque, the setpoint torque is also raised. Therefore, the air mass-dependent correction of the fuel mass is again increased, as a result of which the degree of efficiency is again reduced etc.

Oscillation of the LDA torque, of the setpoint torque, of the air mass-dependent correction value and consequently also of the fuel mass therefore result. This effect occurs the more intensely the more steeply the transition from the value 0 to the value 1 in the weighting factor takes place, that is to say the closer the setpoint torque reference points of the weighting curve belonging to these values lie to one another.

The described instability can be triggered in the same way by the correction of the fuel mass as a function of a start-of-injection correction.

The instability is intended to be prevented by the invention. Refinements of the invention are illustrated in FIGS. 6 and 7.

The proposed method is distinguished in that the correction of the fuel mass is dynamically decoupled from the calculation of the LDA torque.

FIG. 6 shows how this can be implemented when correcting the fuel mass as a function of the air mass ratio. The same components as in FIG. 5 are provided with the same reference symbols:
By filtering the correction value, for example with the aid of a PT₁ filter 230.

By the rotation speed controller I component 234, instead of the setpoint torque 212 in FIG. 5, being used as the input variable 236 of the weighting curve 210.
By the correction value being filtered and, in addition, instead of the setpoint torque, the rotation speed controller I component being used as the input variable of the weighting curve.

FIG. 7 shows a further refinement of the invention.

Reference symbols are assigned as in FIG. 2 and reference is made to the explanations relating to FIG. 2. In addition, a PT₁ filter 75 is provided. Therefore, the degree of efficiency is filtered, for example by a PT₁ filter.

Owing to the filtering, the corrections of the fuel mass are delayed with respect to time. This does not present any problem in practice since the corrections are primarily needed and also ascertained in a static manner. This means that correction of the fuel mass must be carried out as a function of the air mass ratio, in particular when the air mass changes, for example owing to a change in the atmospheric air pressure.

A further refinement of the invention is characterized by the design of the weighting curve of the fuel mass correction. If this has a constant value, for example the value 1, or a flat profile, stabilization of the LDA limit is likewise achieved.

FIG. 9 shows a program flowchart for the calculation of the LDA setpoint torque corresponding to FIG. 7. Firstly, in step S1, the actual engine speed is calculated. Then, in step S2, the setpoint torque is calculated. In step S3, the corrected standard fuel mass is ascertained. The air mass is calculated from the charging-air temperature, the charging-air pressure and the cylinder volume in step S4. Therefore, in step S5, the LDA fuel mass can be determined from the LDA characteristic map.

In step S6, the degree of efficiency is then calculated from the setpoint torque and the corrected standard fuel mass. In step S7, the degree of efficiency is filtered with the aid of a PT₁ filter. The filtered degree of efficiency is multiplied by the LDA fuel mass in step S8.

The result of step S8 is finally the LDA setpoint torque. The process is then continued with step S1 again.

1-8. (canceled)

9. A method for operating an internal combustion engine, comprising the steps of: calculating a setpoint torque from an input variable that represents a desired power: limiting the setpoint torque by a charging pressure-dependent limit; and dynamically decoupling a correction of fuel mass from a calculation of the charging pressure-dependent limit.

10. The method as claimed in claim 9, including using a delay element for the dynamic decoupling.

11. The method as claimed in claim 9, including using a filter is used for the dynamic decoupling.

12. The method as claimed in claim 9, wherein, instead of a setpoint torque, a rotation speed controller I component is used as an input variable of a weighting curve.

13. The method as claimed in claim 12, wherein a weighting curve having a flat or constant profile is prespecified.

14. The method as claimed in claim 9, including dynamically decoupling a calculation of a degree of efficiency from a calculation of an LDA limiting torque in order to stabilize a rotation speed control loop.

15. An arrangement for operating an internal combustion engine carrying out the method as claimed in claim 9, the arrangement being designed to calculate a setpoint torque from an input variable which represents a desired power, wherein the setpoint torque is limited by a charging pressure-dependent limit, and to dynamically decouple a correction of fuel mass from a calculation of the charging pressure-dependent limit.

16. The arrangement as claimed in claim 15, comprising a filter for the dynamic decoupling.
